(19) United States
(12) Patent Application Publication
(10) Pub. No.: US 2010/0187329 A1
(43) Pub. Date: Jul. 29, 2010

(54) FLUID INJECTION DEVICE

(75) Inventors: Andre Agneray, Boulogne (FR); Nadim Malek, Versailles (FR); Laurent Levin, Paris (FR); Marc Pariente, Paris (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., Boulogne Billancourt (FR)

(21) Appl. No.: 12/666,312

(22) PCT Filed: Jun. 25, 2008
(86) PCT No.: PCT/FR2008/051147

§ 371 Date: Apr. 14, 2010

(30) Foreign Application Priority Data
Jun. 27, 2007 (FR) 0704636

(51) Int. Cl. B05B 1/08

(52) U.S. Cl. 239/102.2

(57) ABSTRACT

A fluid injection device having a main injection axis and including at least: a housing; an actuator axially mounted in the housing and including a stack with two axially opposed front faces and including at least one electro-active portion with an electro-active material; and a pre-stressing mechanism adapted for at least partially pre-stressing the stack. The pre-stressing mechanism includes at least a tightening clamp outside the stack and provided between the stack and the housing.

The invention relates to a device for injecting a fluid, for example a fuel, in particular for an internal combustion engine.

More precisely, the invention relates, according to a first of its aspects, to a fluid injection device, called an injector, having a main injection axis and comprising at least:
a casing,
an actuator mounted axially in the casing and having a stack with two axially opposed transverse faces and including at least one electroactive portion comprising an electroactive material, and
a prestress means suitable for prestressing said stack at least partially.

A prestress means suitable for prestressing said stack and, in particular, an electroactive material, for example, piezoelectric ceramic shims or magnetostrictive elements distributed in the stack, is well known to those skilled in the art as is shown, for example, by European patent application EP 1 172 552. Installing this prestres means requires piercing of the electroactive material which weakens it. The ceramic shims crack and break easily when pierced, and/or when assembled, and/or when the injector operates thus reducing its service life.

To prevent problems of electric short circuit that can affect an operation of the injector, an awkward compromise usually has to be made between the compactness of the actuator housed in the casing and the complexity of a spatial distribution of the electrodes with their wires connecting each ceramic shim with means for exciting the electroactive material outside the casing. This makes it hard to assemble the injector since any unexpected contact of the stack against the casing, for example, when the actuator is inserted into the casing, can damage the spatial distribution of the electrodes with their wires.

The main object of the present invention, which is based on this novel observation, is to propose a fluid injection device designed at least to reduce at least one of the abovementioned limitations. For this purpose, the injection device, moreover according to the generic definition given thereto by the above preamble, is essentially characterized in that the prestress means comprises at least one clamping flange outside the stack and placed between the stack and the casing.

Thanks to this arrangement, the piercing of the electroactive material is no longer indispensable, which makes it less fragile, in particular, to mechanical stresses, for example, during assembly and/or operation of the injector. Moreover, the presence of the clamping flange between the stack and the casing protects the stack against an unexpected contact and/or an unexpected crumbling with the casing, for example, during assembly of the injector, that can damage, for example, the spatial distribution of the electrodes with their wires, and even the ceramic material itself.

According to a second of its aspects, the invention relates to an internal combustion engine using the fluid injection device according to the invention, that is to say such an engine in which this injection device is placed.

Other features and advantages of the invention will clearly emerge from the description made thereof below, as an indication and in no way limiting, with reference to the appended drawings in which:

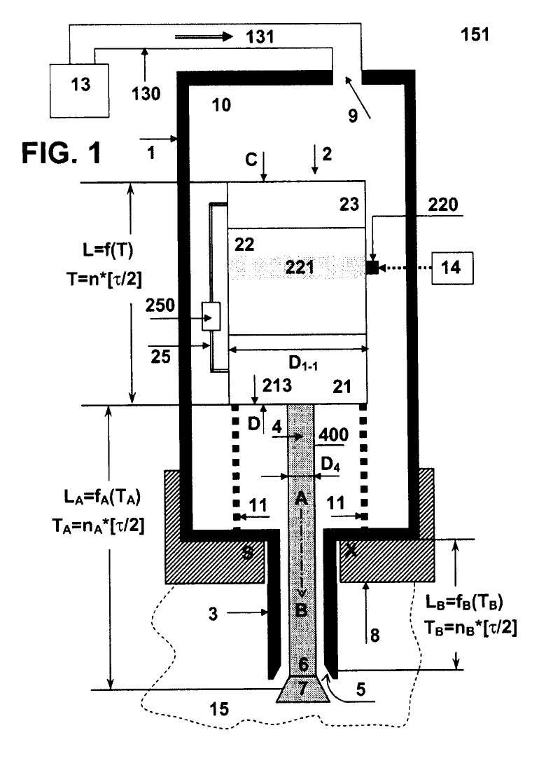

FIG. 1 is a diagram of an injection device according to the invention arranged in an engine and fitted with a needle with a head, called outward facing, connected to an actuator mounted axially in a casing,

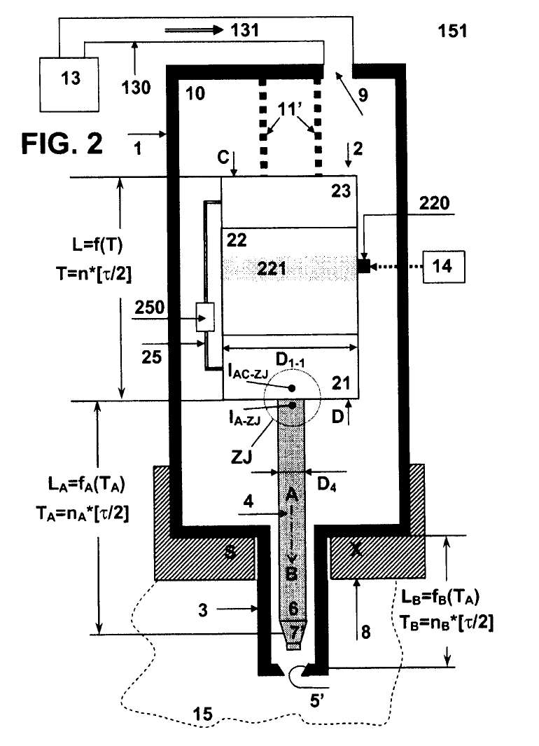

FIG. 2 is a diagram of an injection device according to the invention arranged in the engine and fitted with a needle with a head, called inward facing, connected to the actuator,

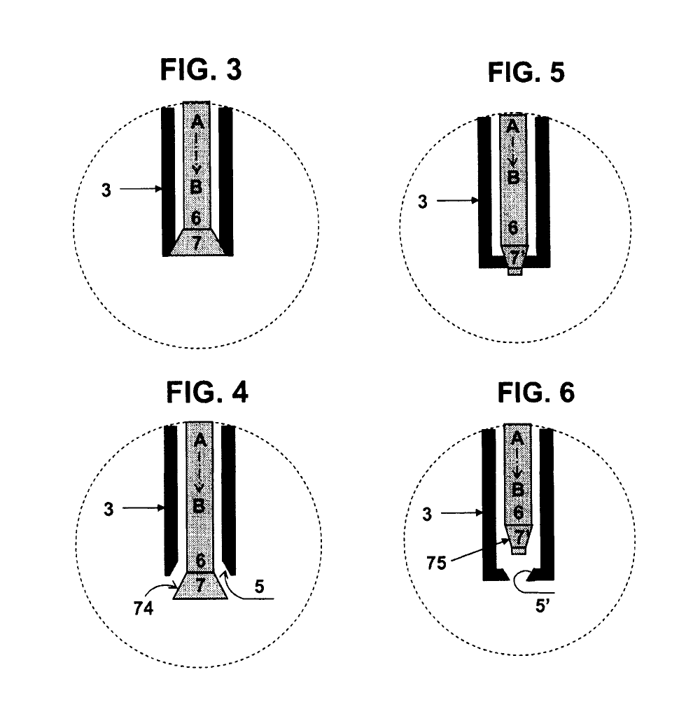

FIGS. 3 and 4 represent diagrams illustrating an operation of the valve element formed by a nozzle and a needle with an outward-facing head: valve element closed (FIG. 3); valve element open (FIG. 4),

FIGS. 5 and 6 represent diagrams illustrating an operation of the valve element formed by a nozzle and a needle with an inward-facing head: valve element closed (FIG. 5); valve element open (FIG. 6),

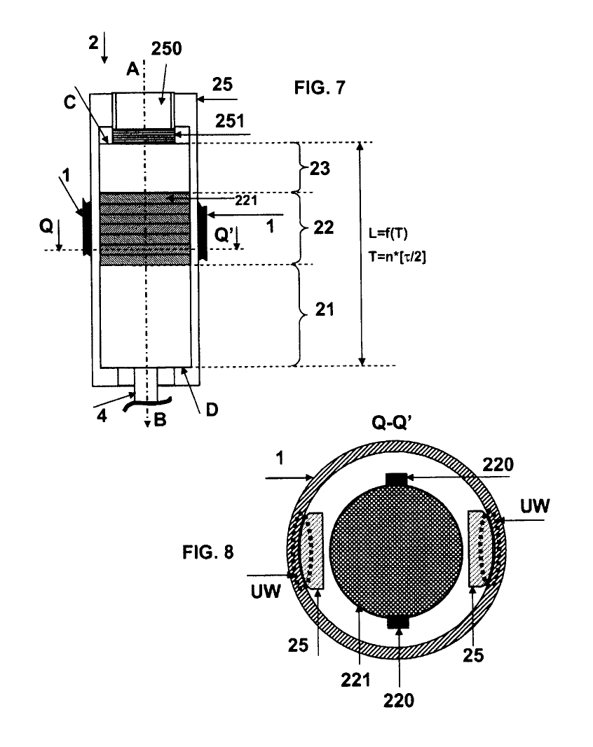

FIG. 7 represents schematically in a simplified side view the stack prestressed by a clamping flange outside the stack and placed between the stack and the casing,

FIG. 8 represents schematically a simplified section of the injector in a plane perpendicular to an axis of symmetry of the injector,

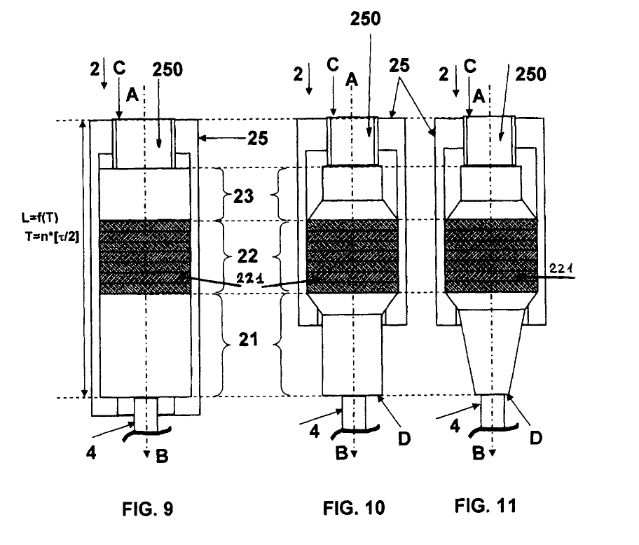

FIGS. 9-11 represent schematically in simplified side views respectively three different diagrams of the stack prestressed by clamping flanges of different structure, a means for adjusting the axial clamping force of the stack being placed axially between each flange and the stack,

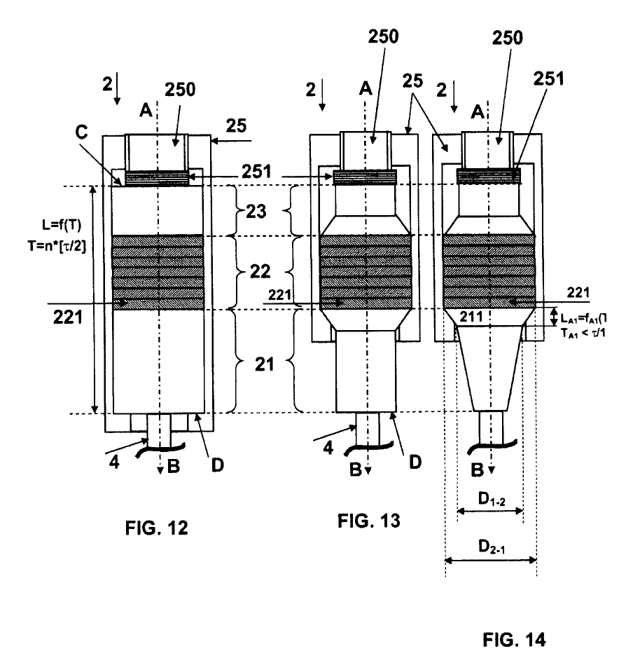

FIGS. 12-14 represent schematically in simplified side views respectively three different diagrams of the stack prestressed by clamping flanges of different structure, the adjusting means supplemented by an elastic means being placed axially between each flange and the stack,

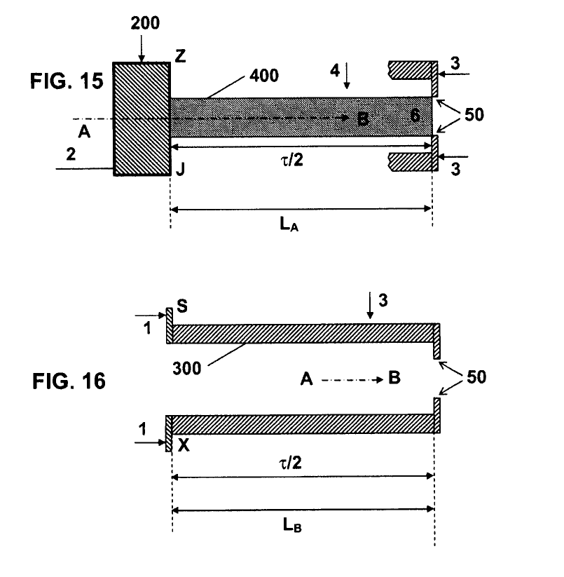

FIG. 15 represents schematically in a simplified side view in partial longitudinal section a one-piece needle in the form of a cylindrical bar,

FIG. 16 represents schematically in a simplified side view in partial longitudinal section a one-piece cylindrical nozzle.

As specified above, the invention relates to an injection device, or injector, designed to inject a fluid, for example a fuel 131 into a combustion chamber 15 of an internal combustion engine 151 (FIG. 1 (or 2)), or into an air intake duct not shown, or into an exhaust gas duct not shown.

The injector comprises two bodies which are for example cylindrical. A first body representing a casing 1 is extended, on a preferred axis AB of the injection device, for example, its axis of symmetry, by at least one nozzle 3 having a length on the axis AB and comprising an injection orifice and a seat 5 (or 5′).

The linear dimensions of the casing 1, for example, its width measured perpendicularly to the axis AB and/or its length measured along the axis AB, may be greater than those of the nozzle 3. The density of the casing 1 may be greater than that of the nozzle 3. The casing 1 may be connected to at least one circuit 130 of fuel 131 via at least one opening 9. The circuit 130 of fuel 131 comprises a device 13 for treating the fuel 131 comprising, for example, a tank, a pump, a filter.

A second body representing an actuator 2 is mounted axially, preferably able to move, in the casing 1. A needle 4 has, on the axis AB, a length and a first end 6 defining a valve element, in a zone of contact with the seat 5 (or 5′) of the nozzle 3. The linear dimensions of the actuator 2, for example, its width measured perpendicularly to the axis AB and/or its length measured along the axis AB, may be greater than those of the needle 4. The density of the actuator 2 may be greater than that of the needle 4. The needle 4 and the actuator 2 are connected together by a zone of junction ZJ (FIG. 2). The first end 6 is preferably extended longitudinally, on the axis AB, away from the actuator 2, by a head 7 (or 7′) closing off the seat 5 (or 5′), so as to ensure a better seal of the valve element of the injector.

The actuator 2 is extended, on the axis AB, by the needle 4, and is arranged in order to directly vibrate the needle 4 with a setpoint period i, thus ensuring between the first end 6 of the needle 4 and the seat 5 (or 5′) of the nozzle 3 a relative axial movement suitable for alternately opening and closing the valve element, as illustrated in FIGS. 3-4 and 5-6. The actuator 2 thus plays a role of an active “master” controlling the needle 4 which then acts as a passive controlled “slave”.

The actuator 2 has a stack with two axially opposed transverse faces C, D and including at least one electroactive portion 22 comprising an electroactive material 221 (FIGS. 7-14). The latter is designed to generate vibrations with a predetermined frequency ν, for example, an ultrasonic frequency that can range between ν=20 kHz to approximately ν=60 kHz, that is to say with the setpoint period τ of vibrations of between respectively 50 microseconds and 16 microseconds. As an example, for a steel, a wavelength λ of vibrations is approximately 10⁻¹ m at λ=50 kHz (τ=20 microseconds). As illustrated in FIGS. 1 and 2, the stack may be indistinguishable from the actuator 2.

The stack comprises at least one portion, called the amplifier 21, axially attached to the needle 4 at the location of one D of said transverse faces C, D, the electroactive portion 22 and the needle 4 being placed axially on either side of the amplifier 21. The latter is designed to transmit the vibrations of the electroactive material 221 to the needle 4 amplifying them so that the movements of the needle 4 at the valve element are greater than the integral of the deformations of the electroactive material 221. The amplifier 21 may have a substantially cylindrical shape (FIGS. 7, 9-10, 12-13). Alternatively, the amplifier 21 may have another shape for example, frustoconical, which narrows in the direction of the axis AB oriented from the electroactive portion 22 to the needle 4 (FIGS. 11, 14).

The stack also comprises at least one other portion 23, called the rear weight 23, playing a role of even distribution of the stresses on the electroactive material 221. The amplifier 21 and the rear weight 23 are placed axially on either side of the electroactive portion 22. The rear weight 23 has a wall axially opposite to the electroactive portion 22, said wall being indistinguishable from the transverse face C of the stack axially opposite to the needle 4.

The amplifier 21, the electroactive portion 22 and the rear weight 23 are, on the one hand squeezed together by a prestress means suitable for prestressing at least partially said stack, and, on the other hand suitable for being traversed by acoustic waves initiated by the vibrations of the electroactive portion 22.

The prestress means comprises at least one clamping flange 25 outside the stack and placed between the stack and the casing 1.

Preferably, the electroactive material 221 is piezoelectric, which may take the form of, for example, one or more ceramic piezoelectric shims stacked axially on one another in order to form the electroactive portion 22 of the stack. The selective deformations of the electroactive material 221, for example, the periodic deformations with the setpoint period τ, generating the acoustic waves in the injector finally culminate in the relative longitudinal movements of the head 7 (or 7′) of the needle 4 relative to the seat 5 (or 5′) or vice versa, suitable for alternately opening and closing the valve element, as evoked above with reference to FIGS. 3-4 and 5-6. These selective deformations are controlled by corresponding excitation means 14 suitable for vibrating the electroactive portion 22 of the stack with the setpoint period τ, for example, with the aid of an electric field created by a potential difference applied, via wires (not shown), to electrodes 220 secured to the piezoelectric electroactive material 221. Alternatively, the electroactive material 221 may be magnetostrictive. The selective deformations of the latter are controlled by corresponding excitation means not shown, for example, with the aid of a magnetic induction resulting from a selective magnetic field obtained with the aid, for example, of an exciter not shown, and, in particular, by a coil secured, for example, to the stack or by another coil surrounding the stack.

The prestress means comprises at least one means 250 for adjusting the axial force for clamping the stack. This allows the prestress means to squeeze the electroactive portion 22, for example, between the rear weight 23 and the amplifier 21, as illustrated in FIGS. 1 and 2, with a force that can be adjusted “on a per-case basis” as a function, for example, of the nature—piezoelectric or magnetostrictive—of the electroactive material 221, and/or of the cross section in a plane perpendicular to the axis AB of the piezoelectric ceramic shims or of the magnetostrictive elements in the stack, and/or of the spatial distribution of said shims in the stack, and/or of their shapes, and/or of their linear dimensions (and/or finally their shapes). The adjusting means 250 may be connected to the clamping flange 25 (FIGS. 1, 2, 7, 9-14).

In particular, it is possible to have the adjusting means 250 placed axially between the clamping flange 25 and the stack (FIGS. 7, 9-10, 12-14). In addition to the fact that this makes the injector easier to assemble, the axial positioning of the adjusting means 250 helps to preserve a structural and/or acoustic symmetry of a “needle 4+actuator 2” assembly so that respectively neither alternating axial back-and-forth movements of the needle 4, nor the propagation of the acoustic waves in the “needle 4+actuator 2” assembly are disrupted by an interfering effect of asymmetric weight.

Preferably, the clamping flange 25 has a thermal expansion (in particular, a coefficient of thermal expansion) that is substantially identical to that of the stack and, in particular to that of the electroactive material 221. For example, the difference between the coefficients of expansion of the electroactive material 221 and of the materials of the stack may be chosen so that the differential expansions of these parts do not induce, in the operating temperature range of the injector, a variation in the prestress of the electroactive material 221 of more than 10% of the nominal stress value (induced by the prestress means 250). For the ceramic electroactive material 221, the clamping flange 25 may be made of an iron and nickel alloy with carbon and chrome, for example, an alloy of the “invar” type. Thanks to this arrangement, the prestress of the electroactive material 221 tends to remain constant irrespective of the temperature variations of the injector. The same expansion of the stack (and in particular of the electroactive material 221 and that of the clamping flange 25) ensures a thermal compensation for the expansions due to the temperature variations of the injector. Assembling the stack and therefore the actuator 2 becomes quicker because it requires no other means for compensating for said thermal expansions. In this embodiment, the rear weight 23 may be indistinguishable from the adjusting means 250 (a situation not shown in the figures).

Alternatively, the clamping flange 25 may have a thermal expansion (in particular a coefficient of thermal expansion) that is different from that of the stack and, in particular, from that of the electroactive material 221. In this case, the prestress means comprises at least one elastic means 251 (for example at least one rubber seal, an elastic shim, a spring) placed between the clamping flange 25 and the stack. The elastic means 251 makes it possible to provide a virtually constant prestress of the electroactive portion 22 and, in particular, of the electroactive material 221, irrespective of the elongations of the clamping flange 25 due to the thermal expansions. Thanks to this arrangement, it is possible to continue assembling the stack and therefore the actuator 2 on an industrial scale, for example, when the invar clamping flanges 25 are out of stock. Therefore this embodiment helps to make the manufacture of the injector more reliable.

Preferably, the elastic means 251 is placed between the stack and the adjusting means 250 (FIGS. 7, 12-14) so as to make the stack quicker to assemble.

Preferably, the adjusting means 250 takes the form of a screw, preferably a threaded screw, the clamping flange for its part having a corresponding drill hole, preferably central, that is to say in line with the axis AB and tapped (FIGS. 7, 9-14).

In particular, the clamping flange 25 rests on the two opposite transverse faces C, D of the stack (FIG. 7), so as to ensure an even distribution of the stresses when the stack is clamped.

The amplifier 21 may have at least one segment narrowing on the axis AB oriented toward the needle 4, for example, a segment 211 for connection with the electroactive portion 22. In this case, the clamping flange 25 may at least partially closely follow the shape of said narrowing segment of the amplifier 21, as illustrated in FIGS. 10-11, 13-14. This makes it possible to reduce an axial length of the clamping flange 25 as can be seen by comparing respectively the clamping flanges 25 in FIGS. 9 and 12 with those in FIGS. 10-11 and 13-14. This possibility of shortening the clamping flange 25 makes it possible either to make the flanges lighter (all other parameters of the flange remaining unchanged), or more resistant (for example, by proportionally increasing a thickness of the shortened flange) to mechanical wear and/or to high clamping forces.

It should be understood that the prestress means may comprise several clamping flanges 25 placed symmetrically around the stack and radially at a distance from one another at a predetermined angle measured in a plane perpendicular to the axis AB. The presence of several flanges ensures the even distribution of the stresses when the stack is clamped.

FIG. 1 illustrates the case of the needle 4 with the head 7, called outward facing, having a divergent flared shape (preferably frustoconical) in a direction of the axis AB oriented from the casing 1 to the outside of the nozzle 3 in the combustion chamber 15. The outward-facing head 7 closes off the seat 5 on the outside of the nozzle 3 oriented away from the casing 1, in the direction of the axis AB.

FIG. 2 illustrates the case of the needle 4 with the head 7′, called inward facing, preferably frustoconical, narrowing in the direction of the axis AB oriented from the casing 1 to the outside of the nozzle 3 and closing off the seat 5′ on the inside of the nozzle 3 oriented toward the casing 1.

Means 11 (or 11′) for returning the actuator 2 may be provided in order to keep the head 7 (or 7′) of the needle 4 pressing against the seat 5 (or 5′) of the nozzle 3 in order to ensure the closure of the valve element irrespective of the pressure in the combustion chamber 15.

The clamping flange 25 and the casing 1 may have at least one longitudinal zone of contact, represented with the aid of the dots referenced UW in FIG. 8. The possible presence of the longitudinal zone of contact UW may make the assembly of the injector easier, in particular by protecting the electrodes 220 against any unexpected contact with the casing 1, for example, during the insertion of the stack into the casing 1 during assembly of the injector furnished with the needle 4 with the outward-facing head 7 taking care to control the frictions and alignments.

The nozzle 3 with the casing 1 and the needle 4 with the actuator 2 form respectively a first and a second medium for propagating acoustic waves. Each of these two media has at least one linear acoustic impedance I which depends on a surface Σ of a cross section of the medium perpendicular to the axis AB, on a density ρ of the medium and on a velocity c of the sound in the medium: I=f_{I}(Σ,ρ,c). To illustrate this ratio, let us examine various simplified examples relating to the needle 4 of the nozzle 3 and illustrated respectively in FIGS. 15-16. For simplification purposes, it is understood that, for all these examples, the second body, the actuator 2 and the stack are indistinguishable. In order to obtain an opening of the valve element of the injector that is not very sensitive to the pressure in the combustion chamber 15, the injector controls the movement of the first end 6 of the needle 4, while the seat (represented in a simplified manner in FIGS. 15-16 and referenced 50) of the nozzle 3 is kept dynamically immobile or fixed while behaving therefore like a movement node.

The needle 4 and the nozzle 3 each take the form of a body the radial dimensions of which perpendicular to the axis AB are small relative to its length along the axis AB. In a solid bar 400 cited here as a simplified model of the needle 4 (FIG. 15) or in a longitudinally pierced bar 300 cited here as a simplified model of the nozzle 3 (FIG. 16), the propagation of the acoustic waves associates the propagation of a jump in tension (force) ΔF₀ and of a jump in speed Δv with the aid of an equation: ΔF₀=Σ*Δσ=Σ*z*Δv, where E is a surface of a cross section of the bar perpendicular to its preferred axis AB, for example, its axis of symmetry, Δσ=z*Δv is a jump in stress, z is an acoustic impedance defined by an equation: z=ρ*c where ρ is a density of the bar and c is a velocity of the sound in the bar. It is understood that the tension F₀ is positive for a compression and the speed v is positive in the direction of propagation of the acoustic waves. The product I=Σ*z=Σ*ρ*c representative of the acoustic properties of the bar—solid or hollow—is called “acoustic linear impedance” or “linear impedance”.

Any variation in linear acoustic impedance I induces an echo, that is to say a weakening of the acoustic wave being propagated in a direction of the bar (for example, from right to left in FIGS. 15-16) by another acoustic wave being propagated in the reverse direction of the bar (for example, from left to right in FIGS. 15-16) from a point of variation in linear impedance I, for example, at a junction between the needle 4 and the actuator 2 (FIG. 15) or at another junction between the nozzle 3 and the casing 1 (FIG. 16). This same reasoning can be applied to any linear impedance breakage I, the term “breakage” having to be understood as “a variation in linear impedance I exceeding a predetermined threshold representative of a difference between the linear impedance upstream and that downstream, relative to the direction of propagation of the acoustic waves, of a zone of linear impedance breakage situated in an acoustic wave propagation medium over a short distance compared with the wavelength, preferably, less than an eighth of the wavelength λ/8”.

The injector may comprise at least one zone of linear acoustic impedance breakage, existing at a distance from the zone of contact of the seat 50 with the first end 6 of the needle 4 along the nozzle 3 (FIG. 16) or the casing 1, and at least one other zone of linear acoustic impedance breakage existing at a distance from the zone of contact of the first end 6 with the seat 50 along the needle 4 (FIG. 15) or the actuator 2. Said zone and other zone of linear acoustic impedance breakage each being first in order from said zone of contact between the first end 6 of the needle 4 and the seat 50, in a direction of propagation of the acoustic waves oriented respectively toward the casing 1 and the actuator 2.

As illustrated schematically in FIG. 1 (or 2), the distance, called the first distance L_{B}, between on the one hand the zone of contact between the seat 5 (or 5′) and the first end 6, and on the other hand the first zone of linear acoustic impedance breakage along the nozzle 3 or the casing 1, is such that the propagation time, called the “acoustic time-of-flight” T_{B}, of the acoustic waves initiated by the electroactive portion 22 of the stack and traveling along this first distance L_{B}=f_{B}(T_{B}) satisfies the following equation:

T_{B}=n_{B}*[τ/2] (E1)

where n_{B} is a multiplying coefficient, a non-zero positive integer, called the first multiplying coefficient, and the distance, called the second distance L_{A}, between on the one hand the zone of contact between the first end 6 and the seat 5 (or 5′), and on the other hand the first zone of linear acoustic impedance breakage along the needle 4 or the actuator 2, is such that the propagation time, called the “acoustic time-of-flight” T_{A}, of the acoustic waves initiated by the electroactive portion 22 of the stack and traveling over this second distance L_{A}=f_{A}(T_{A}) satisfies the following equation:

T_{A}=n_{A}*[τ/2] (E2)

where n_{A} is another multiplying coefficient, a non-zero positive integer, called the second multiplying coefficient, for example n_{A}≠n_{B}.

It should be understood that the equations referenced E1 and E2 above must be considered as verified give or take a certain tolerance in order to take account of the manufacturing constraints, for example, a tolerance of the order of ±10% of the setpoint period τ, that is to say of the order of ±20% of the half-setpoint period τ/2. Taking this tolerance into consideration, the equations referenced E1 and E2 above may be respectively rewritten as follows:

T_{B}=n_{B}*[τ/2]±0.2*[τ/2] (E1′)

T_{A}=n_{A}*[τ/2]±0.2*[τ/2] (E2′)

It should be noted that, in practice, the first distance L_{B}=f_{B}(T_{B}) expressed in acoustic time-of-flight T_{B} and the second distance L_{A}=f_{A}(T_{A}) expressed in acoustic time-of-flight T_{A}, measured on corresponding parts manufactured on an industrial scale, may have slight variations relative to the reference values calculated with the aid of the equations E1 and E2 above. These slight variations may be due to an effect of fitted weights. The latter may correspond, for example, to the head 7 (or 7′) of the needle 4 and/or to a guide boss (not shown) in a plane perpendicular to the axis AB of the end 6 of the needle 4 in the nozzle 3. Said tolerance makes it possible to take account of said effect of fitted weights in order to correct the expressions in acoustic time-of-flight of the first distance L_{B}=f_{B}(T_{B}) and of the second distance L_{A}=f_{A}(T_{A}) with the aid of the equations E1′ and E2′ above.

Preferably, n_{A}=n_{B} for the second and the first multiplying coefficients with, in particular, n_{A}=n_{B}=1 in order to minimize the linear dimensions of the injector on the axis AB in order to leave a maximum of space for inlet and/or exhaust ducts. Therefore, starting from the zone of contact between the seat 5 (or 5′) and the first end 6 of the needle 4, the nozzle 3 has constant acoustic properties on successions of length representative of the first distance L_{B}=f_{B}(T_{B}) that are substantially equal to one another in acoustic time-of-flight and of which the expression in acoustic time-of-flight T_{B} preferably amounts to a single half-setpoint period τ/2. Similarly, starting from the zone of contact between the seat 5 (or 5′) and the first end 6 of the needle 4, the latter has constant acoustic properties over successions of length representative of the second distance L_{A}=f_{A}(T_{A}) that are substantially equal to one another in acoustic time-of-flight and the expression of which in acoustic time-of-flight T_{A} preferably amounts to a single half-setpoint period τ/2.

During an established condition of its operation, that is to say during operation at a predetermined temperature outside the starting and stopping phases of the injector, the latter advantageously makes it possible to alternately open and close the valve element in a manner that is not very sensitive to the pressure in the combustion chamber 15. In the example illustrated in FIG. 1, it involves both controlling the movement of the first end 6 extended by the head 7 of the needle 4 and dynamically keeping the seat 5 of the nozzle 3 immobile. As mentioned above, the movement of the head 7 of the needle 4 is controlled by virtue of the selective deformations, for example, periodic deformations with the setpoint period τ, of the electroactive material 221 of the stack transmitted to the needle 4 via the actuator 2, with the aid of the amplifier 21 (FIG. 1) of the stack. The seat 5 is kept dynamically immobile by virtue of maintaining its longitudinal speed on the axis AB equal to zero, taking advantage of the periodicity of the phenomenon of the propagation of the acoustic waves. Each closure of the valve element during the periodic landings with the setpoint period τ of the head 7 of the needle 4 on the seat 5 generates at impact. The latter generates an acoustic wave, called an incident wave, associating a jump in speed Δv and a jump in stress Δσ. This wave is propagated in the nozzle 3 toward the casing 1 while traveling over the first distance L_{B}, and is then reflected in the first zone of linear acoustic impedance breakage which is indistinguishable in FIG. 1 from a location of recessing SX of the nozzle in the casing 1 with a cross section, in a plane perpendicular to the axis AB, that is much greater than that of the nozzle 3. Once the incident wave has been reflected, its echo, called the reflected wave, returns to the nozzle 3 in order to travel over the first distance L_{B} in the reverse direction, that is to say from the casing 1 to the seat 5. The reflected wave has the same sign of the stress jump Δσ as the incident wave and the opposite sign of the speed jump Δv to the incident wave (the direction of propagation being reversed, the speed jump Δv has changed sign if now all the positive speeds are considered to be in the direction arriving at the seat 5 and no longer in the direction of propagation of the waves). Because the first distance is preferably conditioned by the equation: L_{B}=f_{B}(T_{B})=f_{B}(n_{B}*[τ/2]), the reflected wave reaches the seat 5 exactly at the same moment as a new incident wave is generated by the impact due to the closure of the valve element, the movement of the head of the needle 4 also being conditional upon the second distance L_{A} preferably dependent on a multiple of the half-setpoint period τ/2: L_{A}=f_{A}(T_{A})=f_{A}(n_{A}*[τ/2]). The result of this is that, in the seat 5, the stresses are maintained and the speeds are canceled out. The seat 5 therefore has a movement node. In these conditions, a variation in the pressure in the combustion chamber 15 will induce an amplification of the impacts but without changing their synchronism. The operation of the injector will therefore not be affected by this variation in pressure in the combustion chamber 15.

In the light of the above details, it should be understood that, in the general case for the first and the second multiplying coefficients such as n_{B}≠n_{A}, it is the incident waves and the reflected waves offset by a few periods τ that compensate for one another in the seat 5 in order to make it dynamically fixed. This compensation may not be total when, for example, the difference between n_{B} and n_{A} is greater than a predetermined value and/or a dissipation of the acoustic waves in the nozzle 3 (and finally of its linear acoustic impedance) exceeds a certain threshold. That is why the configuration of the injector with n_{B}=n_{A} and in particular n_{B}=n_{A}=1, appears a priori as being more reliable acoustically and is still preferable to that in which n_{B}≠n_{A}.

It should be understood that the first distance L_{B}=f_{B}(T_{B}) and the second distance L_{A}=f_{A}(T_{A}) respectively with respect to the first “nozzle 3+casing 1” medium and the second “needle 4+actuator 2” medium for propagation of the acoustic waves are preferably defined with the aid of the respective acoustic times-of-flight T_{B}=n_{B}*[τ/2] and T_{A}=n_{A}*[τ/2], in an acoustic context. The latter is due to the presence of the vibrations, for example the ultrasonic vibrations, of the setpoint period τ, initiated by the electroactive portion 22 of the stack indistinguishable from the actuator 2 in the present example, as evoked above. In other words, the first distance L_{B}=f_{B}(T_{B}) and the second distance L_{A}=f_{A}(T_{A}) are between two acoustic limits. In general, a first acoustic limit being used to define both the first distance L_{B} and the second distance L_{A} is represented by one end of an assembly in question (“nozzle 3+casing 1” or “needle 4+actuator 2”). In a simplified manner, it is possible to consider that this first acoustic limit is indistinguishable from the zone of contact between the first end 6 of the needle 4 (if necessary extended axially by the head 7 (or 7′)) and the seat 5 (or 5′) of the nozzle 3, as illustrated in FIG. 1 (or 2).

In the example illustrated in FIG. 1 with the needle 4 with an outward-facing head 7, it should be understood that the first acoustic limit being used to determine the second distance L_{A} in relation with the second “needle 4+actuator 2” medium for propagation of the acoustic waves, is taken halfway up the divergent frustoconical outward-facing head 7. Similarly, the first acoustic limit being used to determine the first distance L_{B}=f_{B}(T_{B}) in relation with the first “nozzle 3+casing 1” medium for propagation of the acoustic waves is taken halfway up the corresponding divergent frustoconical seat 5.

In the example illustrated in FIG. 2 with the needle with the inward-facing head 7′, it should be understood that the first acoustic limit being used to determine the second distance L_{A} in relation with the second “needle 4+actuator 2” medium for propagation of the acoustic waves is taken halfway up the convergent frustoconical inward-facing head 7′.

Similarly, the first acoustic limit being used to determine the first distance L_{B}=f_{B}(T_{B}) in relation with the first “nozzle 3+casing 1” medium for propagation of the acoustic waves is taken halfway up the corresponding convergent frustoconical seat 5′.

The second acoustic limit specific to each of the two assemblies is represented by the respective first zone of linear acoustic impedance breakage I, as detailed above. For example, the second acoustic limit may correspond to the location where the diameter of the assembly in question varies in a plane perpendicular to the axis AB, for example, at the zone of junction ZJ of the needle 4 with the amplifier 21 of the stack or of the location of recessing SX of the nozzle 3 in the casing 1 (FIGS. 1, 2), it being understood that:
in the zone of junction ZJ, the needle 4 and the amplifier 21 are made, for example, by machining in a single piece made of a material preferably having the same density and the same velocity of sound, and
in the location of recessing SX, the nozzle 3 and the casing 1 are made, for example, by machining in a single piece made of a material preferably having the same density and the same velocity of sound.

Specifically, machining in a single piece is the simplest solution to apply during manufacture of said parts on an industrial scale.

It should however be understood that the acoustic limits of the bodies may not correspond to their physical limits. Specifically, in addition to the geometry of the bodies, the acoustic properties reflected, for example, with the aid of the linear acoustic impedance discussed above, also depend on the other parameters such as the density of the bodies and the velocity of the sound in the bodies.

To make the injector perform even better in acoustic terms, the length L measured between the two opposite transverse faces C, D of the stack formed by the amplifier 21, the electroactive portion 22 and the rear weight 23 (FIGS. 1-2, 7,9-14), is such that the time T for propagating the acoustic waves initiated by the vibrations of the electroactive portion 22 and traveling over this length L=f(T) satisfies the following equation:

T=n*[τ/2], (E3)

where n is a multiplying coefficient, a non-zero positive integer, called the third multiplying coefficient, for example, n≠n_{B}≠n_{A}. By analogy with the nozzle 3 and the needle 4, the actuator 2 (indistinguishable in the present example from the stack as already specified above) may therefore have a symmetrical acoustic structure such that an echo of an acoustic wave transmitted in a location of the symmetrical stack tends to return, after one or more reflections at the limits of the stack represented by the opposite transverse faces C, D in FIGS. 1-2, 7, 9-14, in the same location of transmission of the acoustic wave a non-zero positive integer number of periods after its transmission. For example, any acoustic wave running up the needle 4 of the valve element to the actuator 2 and entering (for example when the acoustic recessing of the needle 4 in the actuator 2 is not perfect) the latter via the face D, called the first face of the stack, between the needle 4 and the amplifier 21, is propagated axially in the actuator 2 in order to be reflected subsequently on the face C, called the second face of the stack, opposite to said first face D. By virtue of the symmetrical resonating structure of the actuator 2, a first reflected wave, that is to say a first echo of the wave transmitted to the first face D, returns to this same first face D one period later after its transmission. The same applies to the acoustic waves initiated by the electroactive material 221 of the electroactive portion 22 of the stack and being propagated axially toward the needle 4, which may, in their turn, be reflected on the first face D, return to the actuator 2 to be reflected to the second face C, and then return to the first face D one period later after their departure from the first face D. The symmetrical resonating structure of the actuator 2 therefore generates no delay, nor change of sign of the waves—in particular for that of the sinusoidal type in which a portion of the sine curve that is positive follows a symmetrical portion of the sine curve that is negative—transmitted to the first face D irrespective of the origin of these waves (from the needle 4 or from the actuator 2). The symmetrical resonating structure of the actuator 2 therefore contributes to an ordered operation of the injector.

By analogy with the equations referenced E1 and E2 above, it should be understood that the equation referenced E3 above should be considered as verified give or take a certain tolerance to take account of manufacturing constraints, for example, a tolerance of the order of ±10% of the setpoint period i, that is to say of the order of plus or minus ±20% of the half-setpoint period τ/2. Taking this tolerance into consideration, the equation referenced E3 above can be rewritten as follows:

T=n*[τ/2]±0.2*[τ/2] (E3′)

It should be noted that, in practice, the length L=f(T) expressed in acoustic time-of-flight T and measured on corresponding parts manufactured on an industrial scale may have slight variations relative to the reference values calculated with the aid of the equation E3 above. These slight variations may be due to an effect of fitted weights. The latter may correspond, for example, to appendages or to machinings for gripping or assembly. Said tolerance makes it possible to take account of said effect of fitted weights in order to correct the expression in acoustic time-of-flight of the length L=f(T) with the aid of the equation E3′ above.

For the same reasons as those evoked above with relation to n_{B} and n_{A}, it is preferable for n=n_{B}=n_{A} and, in particular, for n=n_{B}=n_{A}=1.

It should be understood that, because of its geometry (and in particular its thickness measured on a plane perpendicular to the axis AB, negligible relative to the diameter D₄ of the needle 4), its density, its velocity of sound, the clamping flange 25 makes a negligible contribution acoustically. The presence of the clamping flange 25 therefore does not significantly influence the length L=f(T) of the stack expressed in acoustic time-of-flight T.

When the clamping flange 25 has the coefficient of thermal expansion that is the same as that of the stack and, in particular, as that of the electroactive material 221, it should be understood that, acoustically, the second transverse face C of the stack corresponds to that of the adjusting means 250 opposite to the needle 4 (and not to that of the rear weight 23 opposite to the needle 4), the definition already discussed above of the first transverse face D of the stack for its part remaining unchanged, so that the length L=f(T) of the stack still remains between the two opposite transverse faces C, D, as illustrated in FIGS. 9-11.

When the clamping flange 25 has the coefficient of thermal expansion that differs from that of the stack and, in particular, from that of the electroactive material 221, it should be understood that, acoustically, the definitions already discussed above of the first transverse face D and the second transverse face C of the stack remain unchanged (in particular, the second transverse face C of the stack corresponds to that of the rear weight 23 opposite to the needle 4), so that the length L=f(T) of the stack always remains between the two opposite transverse faces C, D, as illustrated in FIGS. 7, 12-14. Specifically, the elastic means 251 has a low linear impedance and the acoustic waves are reflected at the face C forming an interface between the rear weight 23 and the elastic means 251 so that no acoustic wave originating axially from the rear weight 23 penetrates the adjusting means 250 through the elastic means 251. The linear acoustic impedance breakage between the rear weight 23 and the elastic means 251 being total, there is therefore no longer any continuity of the acoustic medium between the rear weight 23 and the adjusting means 250, as indicated in FIGS. 7, 12-14.

1-15. (canceled)

16. A fluid injection device having a main injection axis and comprising:
a casing;
an actuator mounted axially in the casing and comprising a stack with two axially opposed transverse faces and comprising at least one electroactive portion comprising an electroactive material; and
a prestress means for prestressing the stack at least partially,
wherein the prestress means comprises at least one clamping flange outside the stack and placed between the stack and the casing.

17. The injection device as claimed in claim 16, wherein the prestress means comprises at least one means for adjusting an axial force for clamping the stack, the adjusting means being connected to the clamping flange.

18. The injection device as claimed in claim 17, wherein the adjusting means is placed axially between the clamping flange and the stack.

19. The injection device as claimed in claim 16, wherein the clamping flange has a thermal expansion that is different from that of the stack, and the prestress means comprises at least one elastic means placed between the clamping flange and the stack.

20. The injection device as claimed in claim 19, wherein the elastic means is placed between the stack and the adjusting means.

21. The injection device as claimed in claim 16, wherein the clamping flange rests on the two opposite transverse faces of the stack.

22. The injection device as claimed in claim 16, further comprising at least one needle, and the stack comprises at least one amplifier, axially attached to the needle at a location of one of the transverse faces, the electroactive portion and the needle being placed axially on either side of the amplifier.

23. The injection device as claimed in claim 22, wherein the amplifier comprises at least one segment narrowing on the axis oriented toward the needle, and the clamping flange at least partially closely follows the shape of the narrowing segment of the amplifier.

24. The injection device as claimed in claim 16, wherein the stack comprises at least one rear weight, the amplifier and the rear weight being placed axially on either side of the electroactive portion, and the rear weight comprises a wall axially opposite to the electroactive portion, the wall being indistinguishable from the transverse face of the stack axially opposite to the needle.

25. The injection device as claimed claim 16, wherein the clamping flange and the casing have at least one longitudinal zone of contact.

26. The injection device as claimed in claim 24, further comprising excitation means for vibrating the electroactive portion of the stack with a setpoint period τ, wherein the stack is indistinguishable from the actuator, and the amplifier, the electroactive portion, and the rear weight are squeezed together by the prestress means and suitable for being traversed by acoustic waves initiated by vibrations of the electroactive portion.

27. The injection device as claimed in claim 26, wherein the length of the stack, measured between the two opposite transverse faces, is such that the time for propagating the acoustic waves initiated by the vibrations of the electroactive portion and traveling over this length satisfies following equation: T=n*[τ/2], give or take a tolerance and in which n is a multiplying coefficient, a non-zero positive integer.

28. The injection device as claimed in claim 26, further comprising a nozzle comprising, on the axis, an injection orifice and a seat and being connected to the casing at the opposite end,
wherein the needle comprises, on the axis, a first end defining a valve element, in a zone of contact with the seat and being, at the opposite end, connected to the stack of the actuator which sets this needle vibrating, ensuring between its first end and the seat of the nozzle a relative movement suitable for alternately opening and closing the valve element, and
the nozzle with the casing and the needle with the actuator form respectively a first and a second medium for propagating acoustic waves, each medium having a linear acoustic impedance (I) defined by following equation: I=Σ*ρ*c, where Σ is a surface of a cross section of the medium perpendicular to the axis, ρ is a density of the medium, c is a velocity of the sound in the medium,
wherein at least one zone of linear acoustic impedance breakage, existing at a distance from the zone of contact of the seat with the first end along the nozzle or the casing, and at least one other zone of linear acoustic impedance breakage existing at a distance from the zone of contact of the first end with the seat along the needle or the actuator, and
the zone and other zone of linear acoustic impedance breakage each being first in order from the zone of contact between the first end of the needle and the seat, in a direction of propagation of the acoustic waves oriented respectively toward the casing and the actuator.

29. The injection device as claimed in claim 28, wherein a first distance, between the zone of contact between the seat and the first end, and the first zone of linear acoustic impedance breakage along the nozzle or the casing, is such that the propagation time of the acoustic waves initiated by the electroactive portion of the stack and traveling along this first distance satisfies following equation: T_{B}=n_{B}*[τ/2], give or take a tolerance and in which n_{B} is a multiplying coefficient, a non-zero positive integer, and
wherein a second distance, between the zone of contact between the first end and the seat, and the first zone of linear acoustic impedance breakage along the needle or the actuator, is such that the propagation time of the acoustic waves initiated by the electroactive portion of the stack and traveling over this second distance satisfies following equation: T_{A}=n_{A}*[τ/2], give or take a tolerance and in which n_{A} is a multiplying coefficient, a non-zero positive integer.

30. An internal combustion engine using the fluid injection device as claimed in claim 16.
